(19) United States
(12) Patent Application Publication
(10) Pub. No.: US 2025/0354414 A1
(43) Pub. Date: Nov. 20, 2025

(54) MOTOR VEHICLE LOCK

(71) Applicant: Brose Schliesssysteme GmbH & Co. Kommanditgesellschaft, Wuppertal (DE)

(72) Inventors: Ole Haeger, Wuppertal (DE); Serkan Guelkan, Hattingen (DE); Dirk Leve, Neuss-Allerheiligen (DE); Daniel Schulte, Wuppertal (DE)

(21) Appl. No.: 18/873,938

(22) PCT Filed: Jun. 13, 2023
(86) PCT No.: PCT/EP2023/065818

§ 371 Date: Dec. 11, 2024

(30) Foreign Application Priority Data
Jun. 14, 2022 (DE) 10 2022 114 967.6

(51) Int. Cl. E05B 77/54; E05B 81/04; E05B 81/14; E05B 81/56; E05B 81/70

(52) U.S. Cl. CPC E05B 77/54; E05B 81/04; E05B 81/14; E05B 81/56; E05B 81/70

(57) ABSTRACT

A motor vehicle lock having a catch and a pawl, wherein the catch can be brought from an open position into at least one closed position for holding the closure element in holding engagement with a closing element, wherein the pawl can be brought into a blocking state, in which it holds the catch in the closed position, into a release state, in which it releases the catch, and into a contact state, in which the pawl is in contact with the catch in the open position and can be brought into its blocking state in order to allow the catch to be held in the closed position, wherein the motor vehicle lock has an opening device having an electrical opening drive for establishing the release state by motor, wherein the motor vehicle lock has a lock controller for controlling the opening drive.

### CROSS-REFERENCE TO RELATED APPLICATIONS

This application is a national stage application under 35 U.S.C. 371 of International Patent Application Serial No. PCT/EP2023/065818, entitled “Motor Vehicle Lock,” filed Jun. 13, 2023, which claims priority from German Patent Application No. DE 10 2022 114 967.6, filed Jun. 14, 2022, the disclosure of which is incorporated herein by reference.

### FIELD OF THE TECHNOLOGY

Various embodiments relate to a motor vehicle lock, to a motor vehicle lock assembly, and to a closure element assembly.

### BACKGROUND

The known prior art (DE 10 2013 110 201 A1), from which some embodiments proceed, relates to a motor vehicle lock for a closure element of a motor vehicle having the closing elements catch and pawl, wherein the catch is pivotable into an open position and into a main closed position. The pawl can be brought into a blocking state, in which it holds the catch in a closed position, into a lifted state, in which it is disengaged from the catch, and into a contact state, in which it is in contact with the catch in the open position. The motor vehicle lock has an opening device having an opening drive, by means of which the pawl can be brought by motor into its lifted state, and a lock controller for controlling the opening drive. Such a motor vehicle lock can be used as a so-called “electric lock”, which allows the pawl to be transferred into its lifted state solely by motor.

### SUMMARY

A challenge here is to ensure that the catch is not blocked in its closed position by the pawl when the closure element is being dismounted from the motor vehicle and/or when the closure element is subsequently being mounted on the motor vehicle. Corresponding unintentional locking of the motor vehicle lock, in particular when a closure element is closed, can have the result that the pawl can no longer be lifted by motor, for example because the opening device is not connected to a current source and/or voltage source. The pawl then cannot be transferred into its lifted state or can be transferred only with particularly great effort.

Various embodiments are based on the problem of configuring and developing the known motor vehicle lock such that convenience on dismounting of the closure element is improved.

The motor vehicle lock in question can be associated with any closure element of a motor vehicle. In this respect, the term “closure element” is to be interpreted broadly. It includes, for example, a side door, in particular a rear side door, a rear door, a tailgate, a trunk lid, a hood, an engine hood or the like. The closure element can be articulated with the body of the motor vehicle in the manner of a hinged door or in the manner of a sliding door.

In some embodiments, the fundamental consideration is, substantially, to provide an open mode of the motor vehicle lock when the closure element is being dismounted, in which mode the pawl is in its lifted state and/or is brought into that state until the open mode is left. In this way, it can be prevented that the catch is blocked in its closed position by the pawl and the closure element is unintentionally locked, whereby convenience on dismounting of the closure element is improved.

Specifically, it is proposed that the lock controller is coupled or can be coupled with a sensor on the vehicle, on the closure element or on the lock, that the lock controller is configured to detect, by means of the sensor, whether the closure element is mounted on the motor vehicle or has been dismounted from the motor vehicle, and that the lock controller, on detecting the dismounted state of the closure element, transfers the motor vehicle lock into an open mode, which is accompanied by the pawl being brought into its release state and in particular then being held in that state.

In various embodiments, the lock controller is electrically connected to a motor vehicle lock energy source in order to be able to drive the opening drive independently of the on-board power supply of the motor vehicle and detect the sensor.

Various embodiments relate to forms of the sensor. A particularly simple and reliable sensor can be achieved if the sensor is formed by a resistor.

In various embodiments, the motor vehicle lock can be brought into the open mode only when an additional activation criterion is present, whereby unintentional transfer of the motor vehicle lock into the open mode can be avoided.

In various embodiments, the activation criterion can advantageously be suppressed such that the motor vehicle lock cannot be transferred into the open mode.

Various embodiments define the activation criterion, which in some embodiments is formed by the catch in its open position.

According to some embodiments, the motor vehicle lock can be brought from the open mode into a use mode, in which the pawl can also be brought into its contact state and its blocking state again.

According to various embodiments, the motor vehicle lock can be brought from the open mode into a test mode, in which at least one predefined functional condition is checked by the lock controller. If the result is positive, the motor vehicle lock is automatically transferred into its use mode, whereas the motor vehicle remains in its open mode if the result is negative.

Various embodiments relate to the form of the functional condition, for example as a signal of a functional condition sensor, as the effected transfer of the pawl into its contact state or the electrical connection of the lock controller to an energy source.

According to various embodiments, the motor vehicle lock has a holding unit for holding the pawl in its lifted state. If the opening drive cannot be driven backward, it can in a particularly advantageous manner form the holding unit. Alternatively, it is also possible that the holding unit is a functional unit formed separately from the opening drive. In the last-mentioned case, an opening drive that can be driven backward can also be used.

According to various embodiments, the motor vehicle lock can be brought into a factory mode. In the factory mode, transfer of the catch from its open position into its closed position is prevented. In particular a mechanical mounting lock can be provided here, which by mechanical means prevents a corresponding movement of the catch, whereby double protection against a movement of the catch into its closed position is achieved.

According to various embodiments, a motor vehicle lock assembly having a motor vehicle lock as proposed and having a closing part, in particular a closing shackle, with which the catch of the motor vehicle lock can be brought into holding engagement is provided. In this respect, reference may be made to all the observations relating to the motor vehicle lock as proposed.

According to various embodiments, a closure element assembly having a closure element and, associated with the closure element, a motor vehicle lock assembly is provided. In this respect, reference may be made to all the observations relating to the motor vehicle lock assembly as proposed.

Various embodiments provide a motor vehicle lock, in particular for a closure element of a motor vehicle, having a catch and a pawl, wherein the catch can be brought from an open position into at least one closed position, in particular into a main closed position and into a pre-closed position, for holding the closure element in holding engagement with a closing element, in particular a closing shackle, wherein the pawl can be brought into a blocking state, in which it holds the catch in the closed position, into a release state, in which it releases the catch, and into a contact state, in which the pawl is in contact with the catch in the open position and can be brought into its blocking state in order to allow the catch to be held in the closed position, wherein the motor vehicle lock has an opening device having an electrical opening drive for establishing the release state by motor, wherein the motor vehicle lock has a lock controller for controlling the opening drive, wherein the lock controller is coupled or can be coupled with a sensor on the vehicle, on the closure element or on the lock, in that the lock controller is configured to detect, by means of the sensor, whether the closure element is mounted on the motor vehicle or has been dismounted from the motor vehicle, and in that the lock controller, on detecting the dismounted state of the closure element, transfers the motor vehicle lock into an open mode, which is accompanied by the pawl being brought into its release state and in particular then being held in that state.

In various embodiments, the motor vehicle lock has a motor vehicle lock energy source that is electrically connected to the lock controller, or in that the lock controller is electrically connected to a motor vehicle lock energy source formed separately from the motor vehicle lock.

In various embodiments, the sensor is in the form of a capacitive sensor, an ajar sensor, a resistance sensor and/or an optical sensor, in particular in that the sensor is formed by a resistor which is electrically connected to the lock controller when, in some embodiments only when, the closure element is in the mounted state.

In various embodiments, the motor vehicle lock can be brought into the open mode only when an additional activation criterion is present.

In various embodiments, the activation criterion is suppressed in the event of a crash, when a vehicle velocity, in particular greater than 0 km/h or greater than or equal to 3 km/h, is exceeded, when the engine is switched on and/or the ignition is operated, such that the motor vehicle lock is prevented from being transferred into the open mode.

In various embodiments, the additional activation criterion is formed by the manual and/or automatic transfer of the lock controller into an activation state, and/or in that the activation criterion is formed by the catch in its open position, and/or in that an activation sensor is associated with the vehicle lock and the activation criterion is formed by a signal generated by the activation sensor.

In various embodiments, the motor vehicle lock, starting from the open mode, can be brought by means of the lock controller into a use mode, in which the pawl, in addition to the release state, can also be brought into its blocking state and its contact state.

In various embodiments, the motor vehicle lock can be brought by means of the lock controller from the open mode into a test mode, in which the lock controller independently checks at least one predefined functional condition of the motor vehicle lock, in that a positive outcome of the test of the functional condition of the motor vehicle lock causes the motor vehicle lock to be transferred into its use mode, and in that a negative outcome of the test of the functional condition of the motor vehicle lock causes the motor vehicle lock to remain in the open state, in some embodiments in that the motor vehicle lock can automatically be brought into the test mode if the sensor, starting from the dismounted state of the closure element, detects that the closure element has been mounted on the motor vehicle.

In various embodiments, the functional condition is formed by an electrical connection of the lock controller to an energy source and/or a vehicle controller, by a signal of a functional condition sensor and/or by an effected transfer of the pawl into its contact state.

In various embodiments, the motor vehicle lock has a holding unit for holding the pawl in its lifted state, in that the opening drive is configured so that it cannot be driven backward and the holding unit is configured to hold the pawl in its lifted state by the opening drive, or in that the holding unit is a functional unit, in particular a mechanical functional unit, formed separately from the opening drive.

In various embodiments, the motor vehicle lock can be brought by means of the lock controller into a factory mode, in which the catch is prevented from being transferred from its open position into its closed position, in some embodiments in that a mechanical mounting lock is provided, which can be inserted into the motor vehicle lock such that, in the inserted state, a movement of the catch from the open position and/or a movement of the pawl from the lifted state is mechanically blocked.

Various embodiments provide a motor vehicle lock assembly having a motor vehicle lock as provided herein and having a closing part, in particular a closing shackle, with which the catch of the motor vehicle lock can be brought into holding engagement.

Various embodiments provide a closure element assembly having a closure element and, associated with the closure element, a motor vehicle lock assembly as provided herein.

### BRIEF DESCRIPTION OF THE DRAWINGS

Various aspects will be explained in greater detail below with reference to a drawing, which shows only exemplary embodiments. In the drawing

FIG. 1 shows a closure element of a motor vehicle in the form of a front side door having a motor vehicle lock as proposed a) in a state in which it is mounted on the motor vehicle and b) in a state in which it has been dismounted from the motor vehicle, and

FIG. 2 shows the principal components of the motor vehicle lock, according to FIG. 1a) with the catch held in its closed position by the pawl in its blocking state, b) with the catch in its open position and the pawl in its contact state, and c) with the catch in its open position and the pawl in its lifted state.

### DETAILED DESCRIPTION

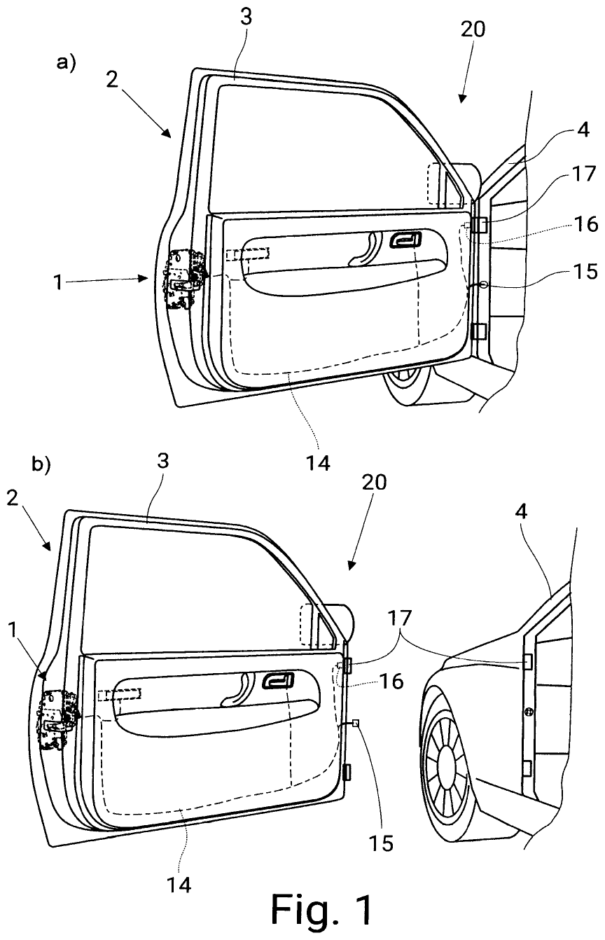

The motor vehicle lock 1 as proposed is part of a motor vehicle lock assembly 2, as shown in FIG. 1. The motor vehicle lock assembly 2 is associated with a closure element 3, which is coupled with a motor vehicle body of a motor vehicle 4. The term “closure element” 3 is here to be interpreted broadly. It includes in particular side doors, rear doors, tailgates, trunk lids, engine hoods or the like. A closure element 3 in this context can in principle also be configured in the manner of a sliding door.

In various embodiments, the closure element 3 is a side door of a motor vehicle 4. All the observations made in this respect apply correspondingly to all other types of closure elements 3.

The motor vehicle lock 1 associated with the motor vehicle lock assembly 2 is arranged, in the mounted state of the motor vehicle lock 1, on the closure element 3. Alternatively, and not shown here, it is also possible for the motor vehicle lock 1 in the mounted state to be associated with the motor vehicle 4.

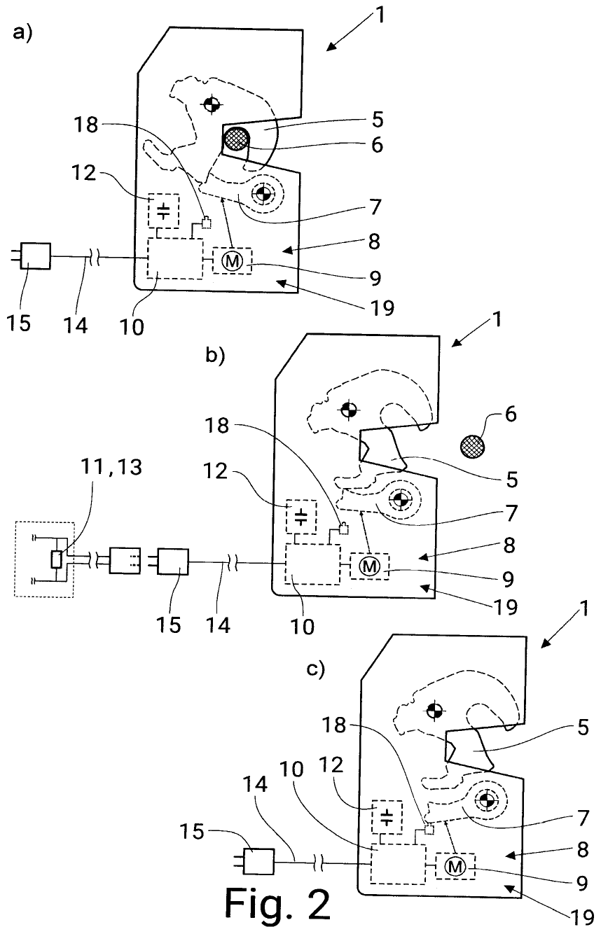

In order to generate a holding action between the closure element 3 and the motor vehicle body of the motor vehicle 4, the motor vehicle lock 1 is equipped with a catch 5, which can be moved into an open position (FIG. 2b) and FIG. 2c)), into at least one closed position, in particular into a main closed position shown in FIG. 2a) and into a pre-closed position between the open position and the main closed position. The catch 5 cooperates in a manner that is conventional per se with a closing part 6, in various embodiments in the form of a closing shackle, in order to hold the closure element 3 in its respective closed position. The catch 5 can be biased, in particular spring-biased, into its open position.

In order to achieve the above holding action, the motor vehicle lock 1 has at least one pawl 7, here exactly one pawl 7. However, the solution as proposed can also readily be applied to a multi-pawl system. For the purposes of a clear representation, however, the following observations relate to an assembly having only a single pawl 7.

The pawl 7 can be moved from a blocking state (FIG. 2a)), in which it blocks the catch 5 in the opening direction in the at least one closed position, into a lifted state (FIG. 2c)), in which it releases the catch 5 in the opening direction. Furthermore, the pawl 7 can be brought into a contact state (FIG. 2b)), in which the pawl 7 is in contact with the catch 5 in the open position, so that it is able to fall into its latching position and thus hold the catch 5 in the closed position when the catch 5 is transferred into its closed position. In the embodiment that is shown in the figures, the contact state of the pawl 7 can be located between the lifted state and the blocking state. In various embodiments, the pawl 7 is biased, in particular spring-biased, into its blocking state.

In various embodiments, the pawl 7 is lifted solely by motor, so that a pure “electric lock” is produced. In order to lift the pawl 7 by motor, the motor vehicle lock 1 has an opening device 8 having a motor-driven opening drive 9. By means of the opening device 8, the pawl 7 can be transferred by motor into its release state.

In addition, the motor vehicle lock 1 has a lock controller 10, by means of which the opening device 8 can be activated and the pawl 7 can be transferred into its release state.

It is important here that the lock controller 10 is coupled or can be coupled with a sensor 11 on the vehicle, on the closure element or on the lock, that the lock controller 10 is configured to detect, by means of the sensor 11, whether the closure element 3 is mounted on the motor vehicle 4 or has been dismounted from the motor vehicle 4, and that the lock controller 10, on detecting the dismounted state of the closure element 3, for example as soon as the closure element wiring harness 14 is disconnected from the on-board power supply of the motor vehicle 4, transfers the motor vehicle lock 1 into an open mode, which is accompanied by the pawl 7 being brought into its release state and in particular then being held in that state.

If the closure element 3 is dismounted from the motor vehicle 4, for example as part of a repair, it is in this way prevented that the catch 5 can be blocked in its closed position by the pawl 7. There is then no question of the motor vehicle lock 1 being transferred into a locked state, whereby unintentional locking of the closure element 3 after it has been mounted on the motor vehicle 4 again or during dismounting is prevented. In this way, a defined, open lock state can be reached, which is established in a reliable manner on dismounting of the closure element 3 and is maintained, at least during dismounting.

In various embodiments, it can be provided that the motor vehicle lock 1 has a motor vehicle lock energy source 12 that is electrically connected to the lock controller 10, or that the lock controller 10 is electrically connected to a motor vehicle lock energy source 12 formed separately from the motor vehicle lock 1. The motor vehicle lock energy source 12 can be a separate energy source that is independent of the energy source for the on-board power supply of the motor vehicle 4.

By means of the motor vehicle lock energy source 12, it is then possible, on the one hand, to drive the opening drive 9 independently of the on-board power supply of the motor vehicle 4 and thus independently of an energy source of the on-board power supply. On the other hand, it is ensured by means of the motor vehicle lock energy source 12 that the lock controller 10 is at any time able to detect, by means of the sensor 11, whether the closure element 3 is mounted on the motor vehicle 4 or has been dismounted from the motor vehicle 4.

It may be advantageous to transfer the pawl 7 by motor into its lifted state as part of a so-called “last opening”, if the motor vehicle lock energy source 12 falls below a limit value for a voltage, a current intensity and/or a quantity of energy. In this way, it can be prevented that the closure element 3 remains in the locked state when the motor vehicle lock energy source 12 discharges, whereby access to the motor vehicle 4 can be prevented.

In various embodiments, the sensor 11 is in the form of a capacitive sensor 11, an ajar sensor, a resistance sensor 13 and/or an optical sensor 11. Thus, the sensor 11 can be in the form of, for example, a camera, which detects whether the closure element 3 is or is not mounted on the motor vehicle 4.

In the embodiment that is shown in the figures, it is provided that the sensor 11 can be formed by a resistor 13, which is electrically connected to the lock controller 10 when, in various embodiments only when, the closure element 3 is in the mounted state. As is indicated in FIG. 2b), the lock controller 10 can be electrically connected to the sensor 11 in form of a resistor 13 when the closure element 3 is in the mounted state and can be electrically decoupled from the sensor when the closure element 3 is in the dismounted state. The lock controller 10 can be connected to the sensor 11 by way of a closure element wiring harness 14, so that disconnection of the closure element wiring harness 12 from the on-board power supply of the motor vehicle 4 results in electrical decoupling between the sensor 11 and the lock controller 10. The closure element wiring harness 14 is here connected to the on-board power supply by way of a closure element disconnection plug 15.

A sensor 11 in the form of a resistor 13 is particularly advantageous and reliable. At the same time, a corresponding sensor 11 makes it possible to monitor particularly easily whether the closure element 3 is or is not mounted on the motor vehicle 4. This can be effected particularly easily by the application of a voltage to the sensor 11.

If the motor vehicle lock 1, as shown in the figures, is associated with the closure element 3, the sensor 11 in the form of a resistor 13 can be associated with the motor vehicle 4. This arrangement may also be reversed. When the motor vehicle door is dismounted, all the electrical connections between the closure element 3 and the motor vehicle 4 by way of the closure element wiring harness 14 are broken, whereby the electrical connection between the sensor 11 in the form of a resistor 13 and the lock controller 10 is also broken.

In order to prevent the motor vehicle lock 1 from inadvertently being transferred into the open mode, for example if the electrical connection to the sensor 11 is unintentionally broken, or in the event of failure of the sensor 11, it is provided, in the embodiment that is shown in the figures, that the motor vehicle lock 1 can be brought into the open mode only when at least one additional activation criterion is present. In this way, it is ensured that the motor vehicle lock 1 can be brought into the open mode only when the at least one activation criterion is present and at the same time it is detected by means of the sensor 11 that the closure element 3 has been dismounted from the motor vehicle 4.

In order to prevent the motor vehicle lock 1 from being transferred into the open mode under defined conditions in which the open mode of the motor vehicle lock 1 is not desired, it is provided, in various embodiments, that the activation criterion is suppressed in the event of a crash, when a predefined vehicle velocity, in particular greater than 0 km/h or greater than or equal to 3 km/h, is exceeded, when the engine is switched on and/or the ignition is operated, such that the motor vehicle lock 1 is prevented from being transferred into the open mode. It is thus possible, for example in the event of a crash or when a motor vehicle 4 is moving, to prevent the motor vehicle lock 1 from being transferred into the open mode and the pawl 7 therefore being transferred into its lifted state and/or being held in that state.

It is possible, in various embodiments, that the additional activation criterion is formed by a manual and/or automatic transfer of the lock controller 10 into an activation state. Thus, for example, the lock controller can be transferred into an activation state by a user, for example by operation of an activation element, such as, for example, a button, a lever or the like. Dismounting of the closure element 3 then automatically leads to the motor vehicle lock 1 being transferred into the open mode.

In the embodiment that is shown in the figures, it can be provided, alternatively or in addition, that the activation criterion is formed by the catch 5 in its open position. The activation criterion is thus present whenever the catch 5 is in its open position. The motor vehicle lock 1 can then be transferred into the open mode only when the catch 5 is open, that is to say if the pawl 7 has previously been transferred into its lifted state. It is then ruled out, in a particularly effective manner, that the motor vehicle lock 1 can be transferred into the open mode if the catch 5 is in its closed position, whereby the reliability of the vehicle lock 1 can additionally be increased.

It is also possible, in addition or alternatively, that an activation sensor 16 is associated with the motor vehicle lock 1 and that the activation criterion is formed by a signal generated by the activation sensor 16. Thus, for example, the activation sensor 16 can be associated with a hinge 17 of the closure element 3. The activation sensor 16 can then be configured to detect whether the closure element 3 is mechanically connected to the motor vehicle 4 by way of the hinge 17. If the sensor 11 detects that the closure element 3 is not connected to the motor vehicle 4 by way of the hinge 17, a corresponding signal can form the activation criterion. In this way, it can be ensured that the open mode is adopted only when the closure element 3 has been dismounted.

It is very important that the motor vehicle lock 1 functions as intended when the closure element 3 is in the mounted state on the motor vehicle 4. It can be provided that the motor vehicle lock 1 can be brought by means of the lock controller 10, starting from the open mode, into a use mode, in which the pawl 7, in addition to the release state, can also be brought into its blocking state and its contact state. This is effected in particular after the closure element 3 has been mounted. The use mode is then initiated in particular automatically when the closure element 3 has been mounted on the motor vehicle 4 again. In this way, re-mounting can be effected particularly easily. In the embodiment shown in FIG. 2b), mounting of the closure element 3 on the motor vehicle 4 is detected as soon as the closure element wiring harness 14 has been connected to the on-board power supply of the motor vehicle 4.

The pawl 7 can then be brought into its three states, the contact state, the blocking state and the release state, whereby use of the motor vehicle lock 1 as intended, and in particular blocking of the catch 5 in its closed position by the pawl 7, is again made possible.

Starting from the use state, transfer of the motor vehicle lock 1 into the open state again is possible by automatic means if the sensor 11 detects that the closure element 3 has been dismounted and the additional activation criterion is present.

It is further provided, in various embodiments, that the motor vehicle lock 1 can be brought by means of the lock controller from the open mode into a test mode, in which the lock controller 10 independently checks at least one predefined functional condition of the motor vehicle lock 1, that a positive outcome of the test of the functional condition of the motor vehicle lock 1 causes the motor vehicle lock 1 to be transferred into its use mode, and that a negative outcome of the test of the functional condition of the motor vehicle lock 1 causes the motor vehicle lock 1 to remain in the open state.

The term “functional condition” is here to be understood as meaning any property that can be checked by the lock controller 10, for example a mechanical position of individual lock components, or an electrical signal. It is then ensured, by means of the lock controller 10, that the motor vehicle lock 1 can be brought independently from the open mode into the use mode when the closure element 3 is mounted on the motor vehicle lock 1 and the predefined functional condition is present, whereby a high degree of user convenience is achieved on re-mounting.

In the embodiment that is shown in the figures, it can be provided that the motor vehicle lock 1 can automatically be brought into the test mode if the sensor 11, starting from the dismounted state of the closure element 3, detects that the closure element 3 has been mounted on the motor vehicle 4. In this way, the test mode is initiated automatically when the closure element 3 has been mounted on the motor vehicle 4 again. In this way, re-mounting can be effected in a particularly simple manner. In the embodiment shown in FIG. 2b), mounting of the closure element 3 on the motor vehicle 4 is detected as soon as the closure element wiring harness 14 has been connected to the on-board power supply of the motor vehicle 4.

The term “functional condition” is here to be interpreted broadly, as has already been described above. In various embodiments, it is provided that the functional condition is formed by an electrical connection of the lock controller 10 to an energy source and/or a vehicle controller, by a signal of a functional condition sensor 18, and/or by an effected transfer of the pawl 7 into its contact state. The energy source can be a current source and/or voltage source. The energy source, in some embodiments, is the motor vehicle lock energy source 12. Thus, it can be provided, for example, that the functional condition is met when the lock controller 10 is electrically connected to the motor vehicle lock energy source 12. Alternatively or in addition, it is also possible that the functional condition is met when the pawl 7 is in its contact state. The functional condition may also be met, for example, by a corresponding signal of a functional condition sensor 18, which is detected by the lock controller 10. Thus, for example, a functional condition sensor 18 can acquire individual positions of motor vehicle lock components and in this way detect movability, in particular by motor, of these components. In FIG. 2c), the functional condition sensor 18 is shown by way of example, the functional condition sensor in FIG. 2c) detecting the position of the pawl 7. Other functional conditions are also possible.

In the embodiment that is shown in the figures, it is provided that the motor vehicle lock 1 has a holding unit 19 for holding the pawl 7 in its lifted state, that the opening drive 9 is configured so that it cannot be driven backward, and the holding unit 19 for holding the pawl 7 in its lifted state is formed by the opening drive 9. The opening drive 9 is then coupled or can be coupled with the pawl 7 in particular such that the pawl 7 can be held in its lifted state by the opening drive 9 and at the same time it is ensured that the opening drive 9 does not prevent the pawl 7, starting from its contact state, from being transferred into the blocking state.

Alternatively, it is also possible that the motor vehicle lock 1 has a holding unit 19 for holding the pawl 7 in its lifted state and that the holding unit 19 is a functional unit, in particular a mechanical functional unit, formed separately from the opening drive 9. The holding unit 19 can have, for example, a blocking lever, which holds the pawl 7 in its lifted state in the open mode of the motor vehicle lock 1. It is then possible for the opening drive 9 to be configured so that it can be driven backward.

Initial mounting of the closure element 3 on the motor vehicle 4 in the context of vehicle production generally takes place before all the vehicle functions are available. In order to be able to prevent the motor vehicle lock 1 from unintentionally being locked during initial mounting, it can be provided that the motor vehicle lock 1 can be brought by means of the lock controller 10 into a factory mode, in which the catch 5 is prevented from being transferred from its open position into its closed position, whereby mounting is facilitated. It is particularly advantageous here for the motor vehicle lock 1 to be able to be transferred from the factory mode, for example into the use mode, only by a user, in particular by manual operation.

In various embodiments, a mechanical mounting lock is provided, which can be inserted into the motor vehicle lock 1 such that, in the inserted state, movement of the catch 5 from the open position and/or movement of the pawl 7 from the lifted state is mechanically blocked. It is then ensured in two ways that the pawl 7 cannot be transferred into the contact state and/or the blocking state.

Finally, it should be pointed out that there are numerous advantageous variants for the configuration of the lock controller 10. For example, the lock controller 10 can be equipped with a computing unit, in particular with a microprocessor, in order to perform the function as proposed. It is, however, also conceivable for the lock controller 10 to be simple cabling with one or more switching elements, which is so made that the function as proposed is performed.

According to further teaching, there is proposed a motor vehicle lock assembly 2 having a motor vehicle lock 1 as proposed and having a closing part 6, in particular a closing shackle, with which the catch 5 of the motor vehicle lock 1 can be brought into holding engagement. Reference may be made in this respect to all observations relating to the motor vehicle lock 1 as proposed.

According to further teaching, there is proposed a closure element assembly 20 having a closure element 3 and, associated with the closure element 3, a motor vehicle lock assembly 2 as proposed. Reference may be made in this respect to all observations relating to the motor vehicle lock assembly 2 as proposed.

1. A motor vehicle lock comprising a catch and a pawl, wherein the catch can be brought from an open position into at least one closed position for holding the closure element in holding engagement with a closing element, wherein the pawl can be brought into a blocking state, in which it holds the catch in the closed position, into a release state, in which it releases the catch, and into a contact state, in which the pawl is in contact with the catch in the open position and can be brought into its blocking state in order to allow the catch to be held in the closed position,
wherein the motor vehicle lock comprises an opening device comprising an electrical opening drive for establishing the release state by motor,
wherein the motor vehicle lock comprises a lock controller for controlling the opening drive,
wherein the lock controller is coupled or can be coupled with a sensor on the vehicle, on the closure element or on the lock, in that the lock controller is configured to detect, by the sensor, whether the closure element is mounted on the motor vehicle or has been dismounted from the motor vehicle, and wherein the lock controller, on detecting the dismounted state of the closure element, transfers the motor vehicle lock into an open mode, which is accompanied by the pawl being brought into its release state and in particular then being held in that state.

2. The motor vehicle lock as claimed in claim 1, wherein the motor vehicle lock comprises a motor vehicle lock energy source that is electrically connected to the lock controller, or wherein the lock controller is electrically connected to a motor vehicle lock energy source formed separately from the motor vehicle lock.

3. The motor vehicle lock as claimed in claim 1, wherein the sensor is in the form of a capacitive sensor, an ajar sensor, a resistance sensor and/or an optical sensor, wherein the sensor is formed by a resistor which is electrically connected to the lock controller when the closure element is in the mounted state.

4. The motor vehicle lock as claimed in claim 1, wherein the motor vehicle lock can be brought into the open mode only when an additional activation criterion is present.

5. The motor vehicle lock as claimed in claim 4, wherein the activation criterion is suppressed in the event of a crash, when a vehicle velocity is exceeded, when the engine is switched on and/or the ignition is operated, such that the motor vehicle lock is prevented from being transferred into the open mode.

6. The motor vehicle lock as claimed in claim 4, wherein the additional activation criterion is formed by the manual and/or automatic transfer of the lock controller into an activation state, and/or in that the activation criterion is formed by the catch in its open position, and/or in that an activation sensor is associated with the vehicle lock and the activation criterion is formed by a signal generated by the activation sensor.

7. The motor vehicle lock as claimed in claim 1, wherein the motor vehicle lock, starting from the open mode, can be brought by the lock controller into a use mode, in which the pawl, in addition to the release state, can also be brought into its blocking state and its contact state.

8. The motor vehicle lock as claimed in claim 7, wherein the motor vehicle lock can be brought by the lock controller from the open mode into a test mode, in which the lock controller independently checks at least one predefined functional condition of the motor vehicle lock, in that a positive outcome of the test of the functional condition of the motor vehicle lock causes the motor vehicle lock to be transferred into its use mode, and wherein a negative outcome of the test of the functional condition of the motor vehicle lock causes the motor vehicle lock to remain in the open state.

9. The motor vehicle lock as claimed in claim 8, wherein the functional condition is formed by an electrical connection of the lock controller to an energy source and/or a vehicle controller, by a signal of a functional condition sensor and/or by an effected transfer of the pawl into its contact state.

10. The motor vehicle lock as claimed in claim 1, wherein the motor vehicle lock comprises a holding unit for holding the pawl in its lifted state, wherein the opening drive is configured so that it cannot be driven backward and the holding unit is configured to hold the pawl in its lifted state by the opening drive , or wherein the holding unit is a functional unit formed separately from the opening drive.

11. The motor vehicle lock as claimed in claim 1, wherein the motor vehicle lock can be brought by the lock controller into a factory mode, in which the catch is prevented from being transferred from its open position into its closed position.

12. A motor vehicle lock assembly comprising a motor vehicle lock as claimed in claim 1 and comprising a closing part with which the catch of the motor vehicle lock can be brought into holding engagement.

13. A closure element assembly having a closure element and, associated with the closure element, a motor vehicle lock assembly as claimed in claim 12.

14. The motor vehicle lock as claimed in claim 4, wherein the vehicle velocity is greater than 0 km/h.

15. The motor vehicle lock as claimed in claim 8, wherein the motor vehicle lock can automatically be brought into the test mode if the sensor, starting from the dismounted state of the closure element, detects that the closure element has been mounted on the motor vehicle.

16. The motor vehicle lock as claimed in claim 11, wherein a mechanical mounting lock is provided, which can be inserted into the motor vehicle lock such that, in the inserted state, a movement of the catch from the open position and/or a movement of the pawl from the lifted state is mechanically blocked.
